(19) United States
(12) Patent Application Publication
(10) Pub. No.: US 2026/0202527 A1
(43) Pub. Date: Jul. 16, 2026

(54) Apparatus for Imaging Pipelines using Real-time Adaptive Ultrasonic Imaging

(71) Applicant: DarkVision Technologies Inc., North Vancouver (CA)

(72) Inventors: Carlos Alberto da Costa Filho, North Vancouver (CA); Reza Zahiri Azar, Burnaby (CA)

(21) Appl. No.: 19/444,456

(22) Filed: Jan. 9, 2026

(30) Foreign Application Priority Data
Jan. 9, 2025 (GB) 2500220.5

(51) Int. Cl. G01S 7/52; G01N 29/06; G01N 29/07; G01S 15/89

(52) U.S. Cl. CPC G01S 7/52028; G01N 29/069; G01N 29/075; G01S 15/8918

(57) ABSTRACT

The disclosure relates to an apparatus and method for imaging fluid-carrying tubulars, such as pipelines and downhole tubing, using real-time adaptive ultrasonic imaging and multiple imaging modalities for a single transducer array. An imaging tool dynamically adjusts beamforming parameters based on the surface characteristics and geometry of an inspected target, to compensate for differences between the actual and expected location of a transducer array relative to the target surface. An imaging tool and method is disclosed that employs multiple transmit and receive cycles to capture various features such as cracks, metal loss, and geometry using a single transducer array, enhancing defect detection and characterization. A tool and method are described for generating image data by compensating for the directionality of a transducer element or array. Further, a method for efficiently ray tracing a region of interest based on a measure of received energy is disclosed.

### FIELD OF THE INVENTION

The current disclosure relates generally to inspection of fluid-carrying tubulars, in particular to an imaging methods and systems for detecting various features such as cracks, metal loss, and geometry using a single transducer array.

### BACKGROUND OF THE INVENTION

Nondestructive testing (NDT) is a way to inspect and evaluate materials, components or assemblies without causing damage. Nondestructive testing may be used to find defects in manufactured parts such as tubulars, pipelines, casings, gears, airplane wings, wheels, and more. In the oil and gas industry, fluid-carrying structures such as pipelines and downhole tubing are critical components for the transportation and extraction of fluids. These structures or tubulars may be a well or pipes for carrying hydrocarbons or water, generally having a long, narrow form factor. A well includes cased and uncased wells within a surrounding formation, at any stage from during drilling to completion to production to abandonment. Cracks are a type of defect that are of particular interest as they are a major cause of failure in manufactured parts. Cracks are often present in welds and seams. Accurate and efficient detection of structural defects is essential for the safe and reliable operation of these structures.

Ultrasonic testing is a favored form of nondestructive testing where ultrasonic waves pass into a material that is being tested and reflect off defects to return to the transducer to be detected. However, it is difficult to detect cracks as the ultrasound waves may not always be reflected from cracks back to the transducer such that they can be detected, or only weak reflections may be generated, requiring the separation of a reflected signal from a crack from amongst all the noise encountered during inspection. Further, the surface from which a crack emanates is often a strong reflector, making it difficult to detect a weaker crack signal. In handheld nondestructive testing applications, cracks may be somewhat easier to detect cracks as the operator can slowly and repeatedly inspect an area while manually interpreting the data on the display. An operator with years of experience can usually detect a crack from interpreting remaining crack signals over a plurality of views.

Automated defect detection, including crack detection, is relevant when inspecting large target surface areas such as pipelines which may be hundreds of kilometers long, downhole casings which may be many kilometers long, or in continuously manufactured products such as parts or slabs of material that may be continuously formed all day. Certain physical aspects about the tubulars such as pipelines and casings are pre-known or assumed, such as the diameter, section length, connection type, and expected weld connection location and orientation, such as transverse welds and longitudinal welds. Identifying cracks over the full extent of the tubulars presents problems for storing acoustic images and processing them. To obtain high resolution images, the transducer array must capture a frame every few millimeters, which typically results in terabytes of data. However, at practical memory limits, frame rates and processing speeds, it becomes very difficult to log pipelines or wells that are many kilometers long.

The inventors have identified a need for improved methods and systems for the automated detection of cracks in pipelines and downhole tubing that overcome the above limitations.

### SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. In accordance with one general aspect there is provided a method of imaging a manufactured part for detecting defects using a phased array ultrasonic transducer. The method also includes emitting one or more ultrasound waves using the phased array ultrasonic transducer. The method also includes receiving reflected ultrasound waves at the phased array ultrasonic transducer to generate a plurality of received signals, and storing the plurality of received signals. The method also includes generating a first image frame from the plurality of received signals via at least one cloud processor, based on an expected model of the manufactured part, the model including a representation of a surface of the manufactured part. The method also includes determining an updated model of the manufactured part, based on the first image frame. The method also includes generating a second image frame via the at least one cloud processor, by: tracing rays from the phased array ultrasonic transducer to the manufactured part and back to the transducer, using the model; determining angles of the traced rays; generating channel weights for the plurality of received signals based on the angles of the traced rays; calculating a time of flight (ToF) for the rays using the model; using the ToF and channel weights, sampling and summing the stored plurality of received signals to calculate image values for pixels for the second image frame; and assembling the pixels to generate the second image frame. The method also includes generating one or more defect measures for the manufactured part based on the second image frame. Other embodiments of this aspect include corresponding computer systems, apparatus, and computer programs recorded on one or more computer storage devices, each configured to perform the actions of the methods.

Implementations may include one or more of the following features. The method where the model representing the manufactured part further includes representations of one or more of: (i) a location of the phased array ultrasonic transducer; (ii) a geometry of the phased array ultrasonic transducer; (iii) a location of the manufactured part; (iv) a geometry of the manufactured part; (v) a speed of sound of a coupling medium between the phased array ultrasonic transducer and the manufactured part; and (vi) a speed of sound of the manufactured part. Generating channel weights further may include assigning a first weight when an angle of a traced ray is less than a first angular threshold, assigning a second weight when an angle of a traced ray is between the first angular threshold and a second angular threshold, and assigning a third weight when an angle of a traced ray is greater than the second angular threshold. The first angular threshold is 55, the second angular threshold is 70, the first weight is 1, the second weight is a scaled cosine function, and the third weight is 0. Generating channel weights further may include assigning channel weights to compensate for an angular-dependent response of the phased array ultrasonic transducer. Assigning channel weights to compensate for an angular-dependent response of the phased array ultrasonic transducer, where a low-pass angular response cutoff of the phased array ultrasonic transducer is less than a desired angular response threshold, further may include assigning channel weights for a range of angles of traced rays below the desired angular response threshold and above the angular response cutoff such that a filtered signal response of the phased array ultrasonic transducer is increased within said range. The one or more defect measures include a crack measure and a wall loss measure. Emitting one or more ultrasound waves further may include emitting one or more of a plane wave, a divergent wave, and a steered wave from the phased array ultrasonic transducer. Emitting a plane wave further may include emitting a full aperture plane wave. Emitting a divergent wave further may include emitting one of a polar wave and a spiral wave. Determining an updated model of the manufactured part is further based on one or more of data from a location sensor for determining a location within the tubular, and a distance sensor for determining a distance travelled within the tubular. Implementations of the described techniques may include hardware, a method or process, or computer software on a computer-accessible medium.

One general aspect includes a method of imaging a manufactured part for detecting defects using a phased array ultrasonic transducer. The method also includes emitting one or more ultrasound waves using the phased array ultrasonic transducer. The method also includes receiving reflected ultrasound waves at the phased array ultrasonic transducer to generate a plurality of received signals, and storing the plurality of received signals. The method also includes generating an image frame from the plurality of received signals via at least one cloud processor, based on an expected model of the manufactured part, the image frame defining a region of interest, by: subdividing a current region of interest into a plurality of subregions of interest; tracing rays for a single reflector back to the transducer, for each of the plurality of subregions of interest; calculating a time of flight (ToF) for the rays using the model, for each of the plurality of subregions of interest; using the ToF, sampling and summing the stored plurality of reflection signals to calculate an intensity value, for each of the plurality of subregions of interest; repeating from a), when the intensity value is greater than a predetermined threshold and the current subregion has been subdivided less than a predetermined number of times, for each of the plurality of subregions of interest; assigning a pixel value based on the intensity value to one or more pixels defined within the corresponding subregion, for each of the plurality of subregions of interest; and generating the image frame based on assigned pixel values. The method also includes storing a configuration of subdivided subregions of interest for an image frame. The method also includes generating one or more defect measures for the manufactured part based on the second beamformed image. Other embodiments of this aspect include corresponding computer systems, apparatus, and computer programs recorded on one or more computer storage devices, each configured to perform the actions of the methods.

Implementations may include one or more of the following features. The method where the at least one cloud processor further may include a graphics processing unit, and where generating the image frame further may include grouping one or more of the plurality of regions of interest to be processed by a warp on the graphics processing unit. Tracing rays for a single reflector back to the transducer further may include defining a single reflector position within each of the plurality of subregions of interest. Subdividing a current region of interest into a plurality of subregions of interest in a) further may include subdividing a current region of interest based on a stored configuration of subdivided subregions of interest. Implementations of the described techniques may include hardware, a method or process, or computer software on a computer-accessible medium.

One general aspect includes a system for imaging a manufactured part for defects. The system also includes an imaging device may include one or more phased array ultrasonic transducers; data memory for storing a plurality of received signals from the one or more phased array ultrasonic transducers; at least one processor; and a computer-readable medium storing instructions that, when executed by the at least one processor, cause the system to image the manufactured part by performing the method of any one of claims Other embodiments of this aspect include corresponding computer systems, apparatus, and computer programs recorded on one or more computer storage devices, each configured to perform the actions of the methods.

Implementations may include one or more of the following features. The system may include at least two radially outward facing phased array ultrasonic transducers. The at least two phased array ultrasonic transducers are radially staggered on the imaging device. The at least two phased array ultrasonic transducers are located diametrically apart. The method is performed simultaneously for each of the at least two phased array ultrasonic transducers. A first phased array ultrasonic transducer from a first tool vehicle and a second phased array ultrasonic transducer from a second tool vehicle are aligned in a radial direction, where the first image frame is generated from a plurality of received signals from the first phased array ultrasonic transducer and the second image frame is generated from a plurality of received signals from the second phased array ultrasonic transducer. Implementations of the described techniques may include hardware, a method or process, or computer software on a computer-accessible medium.

Further aspects of the methods and systems as described herein are set out below and in the appended claims. Thus, preferred embodiments as described herein enable the device to image conduits, such as pipes and wells over long distances, providing the image data for real-time monitoring or subsequent visualization.

### BRIEF DESCRIPTION OF THE DRAWINGS

Various objects, features and advantages will be apparent from the following description of embodiments of the methods, systems and devices as described herein, as illustrated in the accompanying drawings. The drawings are not necessarily to scale, emphasis instead being placed upon illustrating the principles of various embodiments of the methods, systems and devices as described herein.

FIG. 1 is a schematic representation of an imaging device deployed in a pipeline as an inline inspection tool string, in accordance with one embodiment as described herein.

FIG. 2 is a perspective view of an imaging device, in accordance with one embodiment as described herein.

FIG. 3 is a perspective view of an imaging device, in accordance with one embodiment as described herein, including a schematic view of a reference coordinate system.

FIG. 4A is an end view of an imaging tool, in accordance with one embodiment as described herein, in a tubular showing alternative planewaves.

FIG. 4B is an end view of an imaging tool, in accordance with one embodiment as described herein, in a tubular showing alternative planewaves.

FIG. 5 is a perspective view showing a tubular with cracks and corrosion.

FIG. 6A is a schematic view of a transducer array and its imaging field.

FIG. 6B is a schematic view of an acoustic array in an angled arrangement.

FIG. 7 is a block diagram of an imaging device in accordance with one embodiment as described herein.

FIG. 8A is a schematic representation of an imaging device in a first position in accordance with one embodiment as described herein.

FIG. 8B is a schematic representation of an imaging device in a second position in accordance with one embodiment as described herein.

FIG. 9 is an angular response diagram for an angular filter in accordance with one embodiment as described herein.

FIG. 10 is a subdivided image frame in accordance with one embodiment as described herein.

FIG. 11 is a flow diagram for carrying out the method in accordance with one embodiment as described herein.

### DETAILED DESCRIPTION OF THE INVENTION

With reference to the accompanying figures, various aspects of the method, system and device as described herein will now be described. For the purposes of illustration, components depicted in the figures are not necessarily drawn to scale. Instead, emphasis is placed on highlighting the various contributions of the components to the functionality of various aspects as described herein. Several possible alternative features are introduced throughout this description and described accordingly. It is to be understood that, according to the knowledge and judgment of persons skilled in the art, such alternative features may be substituted in various combinations to arrive at different embodiments as described herein. For the sake of simplicity and clarity, the same reference numbers have been used in different figures to show similar or corresponding elements throughout the figures and description.

Devices and methods are disclosed for addressing several challenges in the field of high frame rate imaging of pipes, particularly focusing on various image modalities such as crack detection, wall loss, corrosion, pitting, and geometry that can be performed simultaneously, without compromising on accuracy or efficiency. The disclosed methods and devices overcome issues related to noise generated by conventional beamforming for both transmission and reception, especially when there are deviations in the speed of sound (SoS) and surface geometry from expectations, and variations in standoff that affect incidence angles during steering. In an embodiment, devices and methods are disclosed for steering plane waves at specific angles to detect radial cracks, which are parallel to the pipe surface normal. Beamforming is optimized in real-time based on sensors measurements and detected features, by adjusting transmit and receive delays to account for the geometry of the target tubular. A robust data acquisition system that can manage the high volume of data generated by the different imaging modes is described, as is the use of sophisticated data processing techniques to ensure that the captured data is accurately interpreted and that the imaging results are reliable. Additionally, the issue of crosstalk between probes is addressed, which can affect the quality of the imaging data.

In an embodiment, an acoustic imaging tool generally comprises an imaging device or imaging tool 10 for imaging a fluid-carrying tubular 2 with a generally circular cross section for carrying fluids such as hydrocarbons, natural gas or water, such as an oilwell casing or pipeline, and having an elongate, cylindrical form factor through which an imaging device 10 can move longitudinally. Pipelines typically include multiple beacons 3, at intervals along the length of the pipeline, with access to a communications network. An operations site 18 deploys the device into the tubular and retrieves data from the imaging device 10. The data is processed and visualized at a computer 19, normally remote from the operations site 18. During its lifetime, metal wall loss in a tubular can result from corrosion 6, pitting 7, cracks 8, and milling, or other forms of mechanical damage such as deformation of some or all the sections of the liner due to mechanical stress through compression, tension, and torsion. If the structural integrity of a tubular is compromised, leaks 9 or failures can occur. To assess the condition and environmental impact of the pipe, a tubular can be assessed to identify such wall loss. Remaining wall thickness, which is the obverse of wall loss, can be used to calculate the burst pressure strength of the tubular.

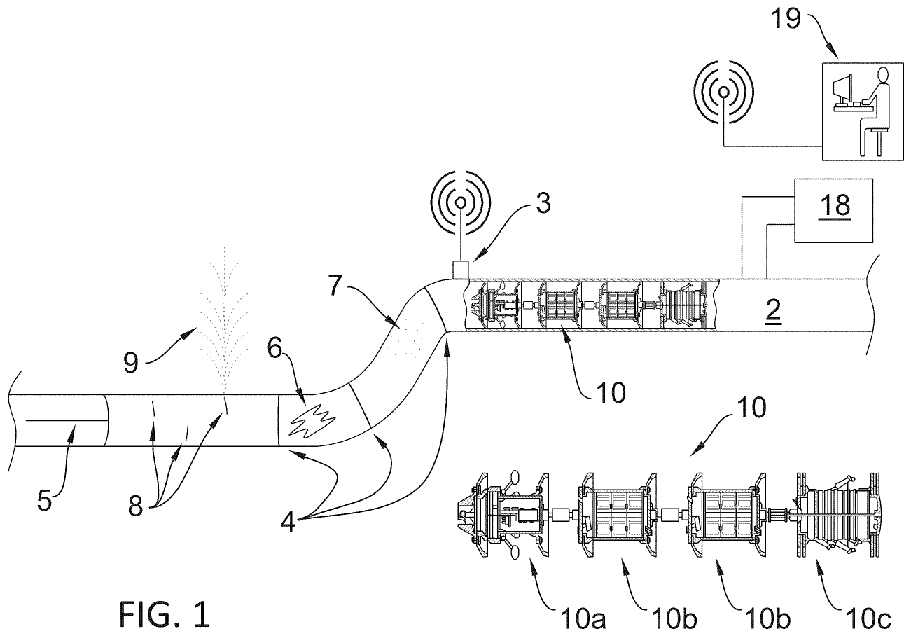

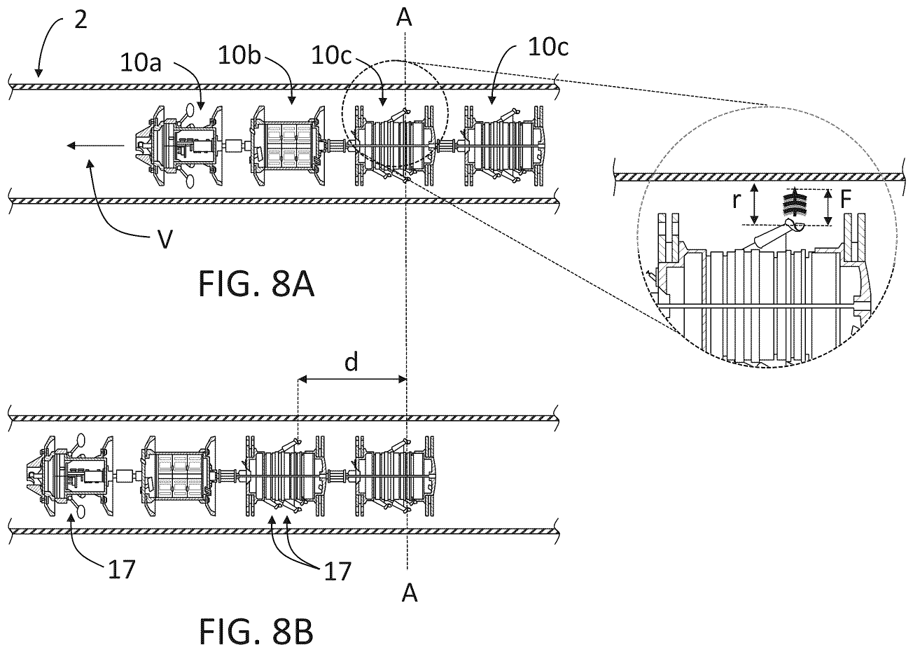

Inspection of pipelines can be achieved with inline inspection vehicles or inline inspection tools, also known as “smart pigs” or “pigs”, which move inside pipelines 2, using a range of sensor technologies to inspect for defects. Inline inspection tools are designed to navigate the complex geometry of pipelines, including bends, valves, and other fittings, while providing detailed information about the pipeline's condition. The imaging device 10 may be an inline inspection tool string comprising multiple tool string vehicles 10a, 10b, 10c, as shown in FIG. 1 and FIG. 8, or operated alone. With reference to FIG. 1, a tool string may include multiple tool string vehicles, such as one or more sensor vehicles 10a, one or more battery vehicles 10b, and one or more imaging vehicles 10c.

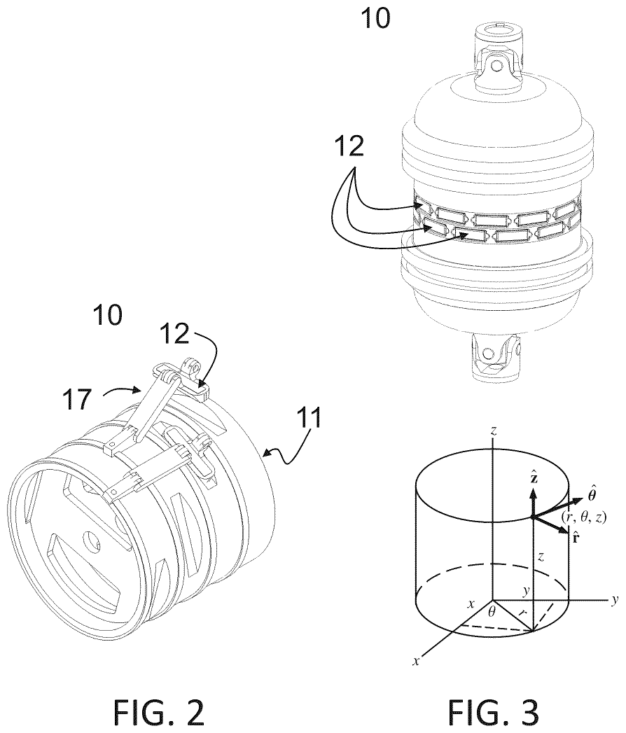

With reference to FIG. 2 and FIG. 3, the tool string vehicles of the imaging device 10 may be a modular inline inspection tool, which is a modular vehicle made up of several swappable, configurable stacked sensor modules 11 that are removably connected to each other, allowing for easy customization and modification for each job. The imaging device 10 typically also has an elongate form factor and is sized to be deployable within the fluid-carrying tubular 2, such as a pipeline or wellbore casing. In embodiments, each sensor module 11 may comprise one or more transducer arrays 12 mounted with each module, the transducer arrays 12 facing radially outward and typically in a rotationally offset fashion to create a helical arrangement of sensors, and electronics, including an on-board processor for operating the sensors and receiving data from the sensors. Each module provides imaging of a certain section of the pipeline, and multiple imaged sections may be combined to visualize the entire pipeline. The tool may also comprise a separate battery vehicle 10b mechanically and electrically connected to the plural sensor modules, sensor arms, drive cups, centralizer discs, heat sinks thermally coupling the electronics to an exterior of the sensor modules, and a control module. The tool is versatile and can be customized on-site for each job, using different sensors or imaging modes.

For clarity in explaining the present method and system, and with reference to FIG. 3, it is assumed that there is a 3D volume of ultrasound data made up of cross-sectional frames (i.e. in the r-Θ plane) of the tubular, which frames are stacked together and extend longitudinally (z). Thus, each frame is an image in coordinates of azimuth and radius (Θ/r), and stacking frames completes the 3D image by incrementing in the axial (z) dimension. The native units for tubular volume may be cylindrical (r, Θ, z) as shown in FIG. 3. Ultrasound reflections are sampled to capture both positive and negative pressures. The signals are demodulated to create images with pixels of absolute signal energy, for example using a Hilbert Transform. A single frame comprises a plurality of scanlines 50 (Θᵢ) by a plurality of samples (time or radius rᵢ), where the brightness of each pixel represents the reflected energy at that time and scanline. The reflections of these acoustic waves from the wellbore or tubular features are converted to digital signals, often called raw radiofrequency (RF) data. The raw RF data may be stored in memory or deconvolved (e.g. using a Hilbert transform) to store intensity values in memory, using the native polar coordinate (r, Θ, z) of the radial array moving axially in the tubular. In embodiments, the data is separated and stored as in-phase (I) and quadrature (Q) components, referred to as I/Q data, which represents the amplitude and phase information of the data signal as separate components. Further processing on this data is maintained in polar coordinates to preserve the data and avoid Cartesian approximations.

In operation, a typical data flow includes acquiring cross-sectional frames of the tubular and storing them as scanlines, which creates a natively polar coordinate system for a radial array. During subsequent visualization, the stored images can be visualized in the polar domain directly, or may be converted to Cartesian coordinates, with neighboring polar pixels combined for each Cartesian pixel, and rendering makes the compiled images of the tubular into an intuitive display. These Cartesian images are loaded into video memory as X, Y, Z pixels (aka voxels). A GPU operates on these Cartesian pixels to create visualization appropriate to a 2D monitor used by operators. The scan conversion from acquired ultrasound images to displayed images can be pre-computed for efficient viewing.

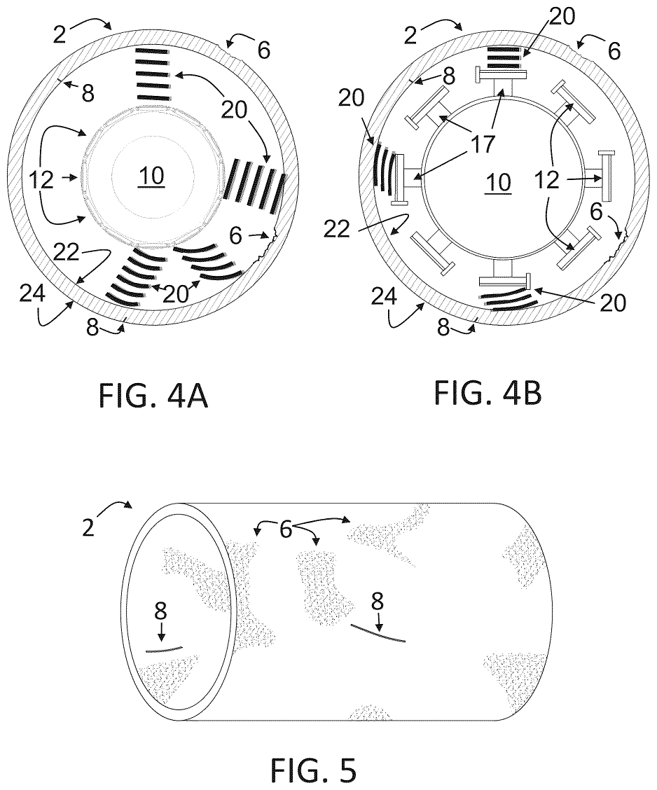

With reference to FIG. 4A and FIG. 4B, the imaging device 10 comprises one or more transducer arrays 12. In one embodiment, the transducer arrays 12 are formed as an outward-facing radial arrangement that insonify a cross section of the wellbore or tubular 2, from a standoff distance, generating transmitted waves 20 that travel along scanlines 50, towards the inner surface 22 of the tubular, and a portion of the ultrasound wave continues outwards to the outer surface 24 of the tubular 2. In an embodiment, the one or more transducer arrays 12 are circumferentially arranged on the body of the imaging tool 10, as illustrated in FIG. 4A, which results in transducer arrays 12 located diametrically apart on the body of the imaging tool 10. The transmitted waves 20 may be a plane or curved wavefront, the former having a flat front and the latter having a front that is substantially curved or arc-shaped. Curved/arc-shaped waves can be seen as the polar coordinate equivalent of planar waves. While multiple transmitted waves 20 are illustrated in FIG. 4A and FIG. 4B, these may be transmitted concurrently or independently. As the imaging device 10 moves longitudinally in the z direction through the tubular 2, the one or more transducer arrays 12 capture frames of data of these cross sections, preferably on the order of millimeters. Wellbore or tubular features include pre-known physical aspects of a tubular such as transverse welds 4 and longitudinal welds 5, or features due to wear and deterioration, including corrosion 6, pitting 7, cracks and holes 8, and physical deformation.

In embodiments, each of the one or more transducer arrays 12 are located on sensor arms 17 which extend from the body of the imaging tool 10. Sensor arms allow the sensor to closely inspect the surface of the pipeline while accommodating dents, diameter changes and bends in the pipeline. In an embodiment, the sensor arms are rotatable, and comprise a transducer array 12, one or more pipeline engaging wheels, and biasing means. Each rotatable sensor arm 17 further comprises a rotational encoder operatively coupled thereto which provides encoder angle data which is continuously monitored, recorded and synchronized with the ultrasound data, to generate an accurate representation of the target geometry. The encoder angle data provides a known radial distance outward from the sensor module, or standoff distance, for each frame in the sensor logs, which can be used to reconstruct an image or a geometric model of the pipe, or can be used to update transmit, dwell and receive parameters for an ultrasound signal, update beamforming parameters, and other data acquisition adjustments, as described in more detail below.

In an embodiment, transmit and receive delays, as described in further detail below, for transducer elements 13 in one or more transducer arrays 12 are selected based on a boundary location of a curved surface or radius of a target 2. In an embodiment, signals are concurrently emitted and received from and to multiple transducer arrays 12 of an imaging tool 10, such that transducers on substantially opposite sides of the imaging tool are activated at the same time.

Each transducer array 12 comprises a plurality of acoustic transducer elements 13, preferably operating in the ultrasound band. The frequency of the ultrasound waves generated by the transducer(s) is generally in the range of 200 kHz to 30 MHz, and may be dependent upon several factors, including the fluid types and velocities in the well or pipe and the speed at which the imaging device is moving. The use of a relatively large number of elements generates a fine resolution image of the object. In most uses, the wave frequency is 1 to 10 MHz, which provides reflection from micron features. The transducers may be piezoelectric, such as the ceramic material, PZT (lead zirconate titanate). Such transducers and their operation are well known and commonly available. Circuits 14 to drive and capture these arrays are also commonly available, as described in more detail below.

The number of individual transducer elements 13 in the transducer array 12 affects the azimuthal resolution of the generated images. Typically, each transducer array is made up of 32 to 2048 elements and preferably 128 to 1024 elements. The logging speed and frame rate determines the axial resolution. An acoustic wave created by one or more of these elements, such that energy is generally focused along a line to form a what is called a scanline 50. The scanlines are then assembled by the processor to form one frame that approximates one slice of the imaged location. These slices are assembled into a 3D volume in a process called slice stacking.

In an embodiment, transducer elements 13 are arranged as an evenly spaced one-dimensional transducer array 12. In an embodiment, the transducer elements 13 are arranged as part of multiple transducer arrays 12, for example, as illustrated in FIGS. 2, 3, 4A and 4B. In such embodiments, the top surface of each of the transducer elements 13 faces radially away from the imaging tool 10 towards the wall of the target or tubular 2. In an embodiment, the transducer elements are distributed around a section of the circumference of the tool housing, and this transducer arrangement captures a cross-sectional slice of the well covering an arc of the tubular. In an embodiment, the transducer elements are arranged as a linear array on an extendable tool arm, and this transducer arrangement captures a cross-sectional slice of the well covering an arc of the tubular. As the imaging tool is moved axially in the well or pipe, in either direction, the transducer continually captures slices of the well that are perpendicular to the longitudinal axis of the well. Thousands of these slices are combined to create a 3D visualization of the well.

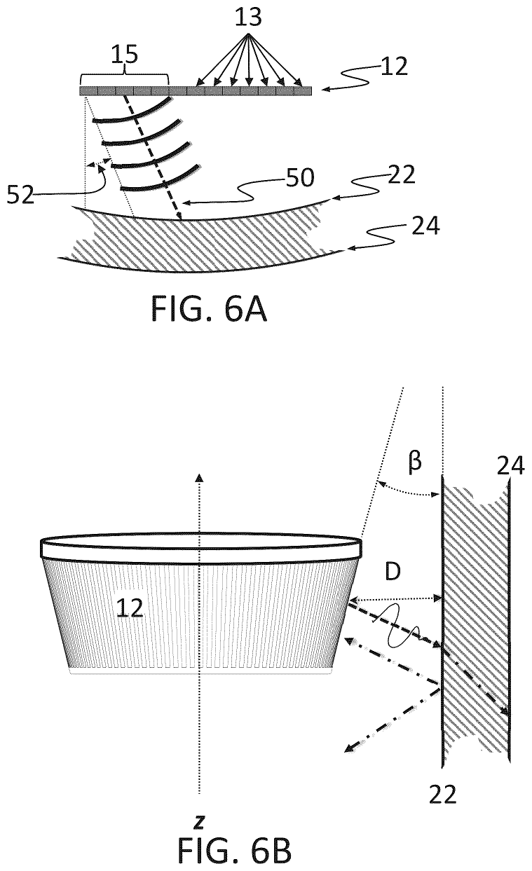

An acoustic transducer element 13 can both transmit and receive sound waves. The shape and size of an array, or limitations of the electronics may mean that each transmit and receive event takes place on less than the full physical array, i.e., an aperture 15. The aperture 15 is a set of neighboring transducer elements that individually contribute towards the constructive wavefront and increase its acoustic energy. The number N of scanlines 50 that make up a full frame may be the same as the number of elements M in the array, but they are not necessarily the same. For example, a 256-element array may operate with a 64-element transmit aperture that slides from one side to the other, capturing many smaller scanlines than if the whole array were pulsed and received at once. The elements in the aperture are selected from the whole array by multiplexors. Normally these are a symmetrical set of elements opposite the part spot to be insonified, i.e. the spot and aperture center have the same azimuthal angle θ. Multiple transducer elements 13, per aperture 15, operate in a phase delayed mode to generate a scanline. There may be as many scanlines 50 as elements by changing the aperture by a single element for each scanline. The apparent origin of the wave can be synthesized within the device, referred to as a transmission point, by the set of transducers, or the aperture 15. In FIG. 6A, a non-limiting exemplary scanline 50 appears to radiate out (dashed line) from the center of the five transducer elements 13 in aperture 15. In embodiments, a scanline 50 may be steered at angle 52.

In an embodiment, the one or more transducer arrays 12 are formed as an outward-facing arrangement, on a surface angled to form an oblique-shaped field of view, at an angle β of 10-45°, preferably about 20°, as shown in FIG. 6B. In yet a further embodiment, the one or more transducer arrays 12 are formed as a frustoconical outward facing arrangement, angled to form an oblique-shaped field of view, at an angle β of 10-45°, preferably about 20°. Thus, in these embodiments, the transducer elements are distributed on a surface with transducer elements 13 facing partially in the longitudinal direction of the device. In this arrangement, much of the sound wave reflects further down the tubular, but a small portion backscatters off imperfections on the surfaces or voids within the wall, back towards the transducer, per PCT Application WO 2016/201583 published Dec. 22, 2016 to Darkvision Technologies. FIG. 6B shows acoustic pulses transmitted towards the inner wall, most of which bounces downward (as represented by the dashed lines) and some backwards (not illustrated) to the transducer elements 13. Some of the wave energy propagates to the outer wall, then bounces downward and partially back to the transducer. Note that the angles of the waves and reflected waves in FIGS. 4A, 4B, 6A and 6B aren't necessarily shown accurately, but in a manner that allows for the conceptualization of the waves.

The timing of each scan comprises a transmission window Tx, receiving window Rx and dwell period therebetween. As used herein, a scanline 50 is the stream of data received during Rx and may be provided in physical coordinates using the speed of sound. During transmission, the transducers are excited with an electrical pulser, which pulse may be square, sinusoidal or other waveform. At the end of Tx there is a dwell period while the wave travel outs and back to the transducer element or aperture. During the Rx window, the circuit ‘listens’ to reflections at the transducer element or aperture. There may be multiple reflections along paths of various lengths, so the Rx window is much wider than the Tx window. The reflections are received at the transducer elements 13. The electrical signals of the reflections may be stored in raw form for later, offline beamforming and image reconstructions. Alternatively, the signals are beamformed in real time and the reconstructed image is stored on the imaging device.

In ultrasound arrays, multiple discreet omnidirectional pulses are emitted from the plural transducer elements 13, which waves interfere constructively and destructively to produce a wavefront moving in the direction of the scanline. As known in the art, altering the timing of the pulse at each transducer element, can steer and focus the wavefront. In steering, the combined wavefront appears to move away in a direction that is not orthogonal from the transducer face, but still in the plane of the array. In focusing, the waves all converge at a chosen distance from the elements 13. The location of the convergence is the focal point and the area insonified defines the resolution of the system. The transmitted wave may or may not be focused at a point on the surface to be imaged. U.S. Pat. No. 5,640,371 provides a method and apparatus for acoustic imaging using beam focusing, beam steering and amplitude shading to increase image resolution and overcome side lobe effects, which may be used in pipelines.

The transmitted wavefront may be described as ‘coherent,’ ‘weakly focused,’ ‘defocused,’ ‘unfocused,’ ‘plane wave’, ‘spherical’, ‘spiral’, ‘divergent,’ or ‘non-convergent’ in as much as the transmitted waves may have some theoretical focal point within or behind the transducer. The transmitted waves may be a plane or curved wavefront, the former having a flat front and the latter having a front that is substantially curved or arc-shaped. Curved/arc-shaped waves can be seen as the polar coordinate equivalent of planar waves. These shapes are created by phase delays of the pulses emitted by each transducer element. Notably, these fronts do not converge or focus on the surface of the target. The transmitted wavefront from the transducer towards a curved target, such as a pipeline or casing, can be an arc, rather than a flat plane wave. Preferably, a curved wavefront hits the inside of a tubular target at the same angle of incidence relative to the normal of the surface of the tubular along the whole area of sonification. The angle of incidence is what defines the overall steering angles for a transmit. This transmit may be computed by ray tracing, knowing the array position relative to the pipe, pipe geometry, speed of sound of fluid, and array geometry.

Receive beamforming is understood by persons skilled in the art of ultrasound. In broad terms, the processor uses plural phases delays, pre-stored in a memory (e.g. look-up-table, or LUT) that convolve/shift the signals based on different focal depths. These signals are combined to reconstruct a final image, whereby weakly focused reflections get diluted and strongly focused reflections are reinforced. As an example, “Delay and Sum” beamforming technique can be used for this purpose. In some embodiments, the received signals undergo apodization before beamforming to reduce sidelobes and to improve image quality.

In conventional imaging, images are formed by beamforming one line at a time. This will drastically reduce the acquisition rate. In order to speed up the beamforming, the same channel data can be used with slightly different delays in order to generate multiple lines, which in preferred embodiments can be extended to generate an entire image slice around the tubular from a single transmit event. This is done by running parallel beamforming on all the scanlines at the same time. This is computationally intensive but allows for much faster image reconstruction.

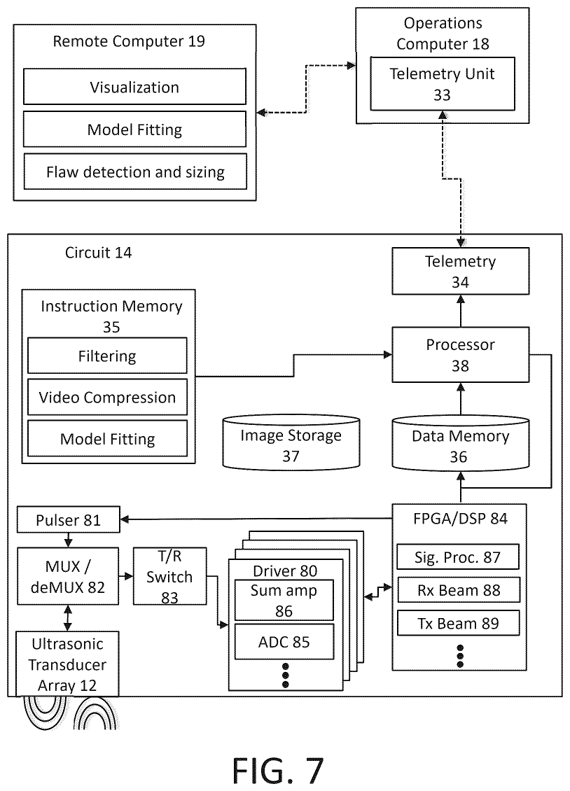

The device comprises a processing circuit for generating and receiving signals from the transducers. The skilled person will appreciate that the circuit may implement logic in various combinations of software, firmware, and hardware that store instructions process data and carry out the instructions. Specialized ultrasound circuits exist to drive and receive arrays of ultrasound transducers, such as LM96511 from Texas Instruments. FIG. 7 is a block diagram of components of the device's on-board circuits 14 and remote computing system 19, including an onboard computer processor 38 (for display and post processing), FPGA block 84, Summing Amps 86, ADC 85, MUX/DEMUX 82, High Voltage T/R switch 83, High Voltage Pulser 81, and timing chips. The FPGA is an efficient chip for integrating many logical operations. The block may comprise Tx beamforming 89 and Rx beamforming 88, DVGA control (Digitally controlled Variable Gain Amplifiers, not shown), as well as data processing operations 87, such as B-mode (brightness mode) and Doppler processing. Although not shown, the circuit may additionally comprise motor drivers and memory chips. By way of example, the transmission step may include selecting the transducer elements 13 in the aperture 15, calculating beamforming timings, loading the pulse timings from the FPGA 84, activating the pulser 81 and MUXes 82 to pulse all elements. Beamforming timings include timings necessary for steering and focusing an ultrasound wave within the active plane. In embodiments, the dwell period is set based on a nominal diameter of the pipe and speed of sound in the well fluid. In embodiments, the Rx window is set to capture reflected pulses based on the known, measured or nominal parameters of the target and of the surrounding physical environment. The raw image data is initially stored in memory 36. This may be Terabytes of data. Instructions running on the remote processor include modules for digital receive beamforming, compound processing, flaw detection and sizing calculations and visualization. Intermediary images, such as a single beamformed image or the compounded image may be stored on the same or separate storage 37. FIG. 7 illustrates a preferred division of resources for the method described above. However, as computing resources improve, certain processes could be moved onto the device, such as beamforming and compounding. This could also be done during the downtime of the device, when not actively imaging. In this manner, the recovered device is ready to upload fully compounded images to the remote computer for immediate visualization.

Without loss of generality, each of the circuit and electronic components described with reference to FIG. 7 may comprise multiples of such chips, e.g. the memory may be multiple memory chips. For the sake of computing efficiency, several of the functions and operations described separately above may be combined and integrated within a chip. Conversely certain functions described above may be provided by multiple chips, operating in parallel. For example, the LM96511 chip operates eight transducers, so four LM96511 chips are used to operate an aperture of 32 transducers.

It will be appreciated that data processing may be performed with plural processors: on the device, at the operations site, and optionally on a remote computer. The term ‘processor’ is intended to include computer processors, cloud processors, microcontrollers, firmware, GPUs, FPGAs, and electrical circuits that manipulate analogue or digital signals. While it can be convenient to process data and execute stored instructions on a processor to carry out steps as described herein, using software on a general computer, many of the steps could be implemented with purpose-built circuits.

It will be appreciated that the various memories discussed may be implemented as one or more memory units. Non-volatile memory is used to store the compressed data and instructions so that the device can function without continuous power. Volatile memory (RAM and cache) may be used to temporarily hold raw data and intermediate computations. Additionally or alternatively, the compressed images may be transmitted over a telemetry unit of the device to a corresponding telemetry unit of the surface computer system.

The imaging device 10 may further comprise an acoustic lens covering an outer surface of one or more of the transducer arrays 12. The acoustic lens may be convex or concave, or may be a concave or convex logarithmic lens having an extended focal zone. The skilled person will appreciate that focusing also depends on the relative speed of sound from the lens material to fluid.

In one embodiment, a convex lens is used. The convex lens is made of a material having an acoustic velocity less than the acoustic velocity of the fluid in the tubular. Typically, well fluid has an acoustic velocity of approximately 1300 to 1700 m/s. A suitable lens material having a lower acoustic velocity is room temperature vulcanization (RTV) silicone, which has an acoustic velocity of approximately 900 to 1050 m/s. With a convex lens, the elevation of the transducer array elements is generally from 5 to 50 mm, depending on the lens curvature and size of the tubular, and preferably 15 mm.

In another embodiment, a concave lens is used. The material of the concave lens preferably has an acoustic impedance close to the fluid in the tubular, and has a higher acoustic velocity than the fluid within the tubular. Suitable materials include hard plastics such as polymethylpentene (PMP) (e.g. TPXTM), polystyrene (PS), and poly(methyl methacrylate) (PMMA). The elevation of the transducer elements is generally from 5 to 50 mm depending on lens curvature and size of the tubular, and preferably 15 mm.

In a further embodiment, a logarithmic lens is used. The logarithmic lens is shaped to create an extended focal zone that can produce sharp images at a range of distances, i.e. images having a high depth of field. Having an extended focal zone is advantageous because a range of depths from inside a tubular to the outside of the casing or liner and everything in between can be imaged with the same tool. An extended focal zone also allows for wells having different diameters to be imaged with the same tool. The logarithmic lens can be concave or convex. A concave logarithmic lens would be made of a material having a higher velocity than the fluid in the tubular, such as polymethylpentene (PMP) (e.g. TPXTM), polystyrene (PS) or poly(methyl methacrylate) (PMMA). A convex logarithmic lens would be made of a material having a lower velocity than the fluid within the tubular, such as RTV silicone. The elevation of the transducer elements is generally from 5 to 50 mm depending on lens curvature and size of the tubular, and preferably 15 mm.

The imaging device 10 may include one or more centralizing elements, such as centralizer discs or other suitable means, for keeping the vehicle centered within the tubular for imaging quality. In the preferred embodiment, the device is concentric with the tubular, i.e. the longitudinal axis of the imaging device 10 is generally aligned with the longitudinal axis of the well or pipeline. Therefore, scanlines radiate perpendicular out from transducer elements 13, arrive focused and perpendicular to the well or pipe surface, and reflect back to transducer elements 13. The times of flight (ToF) for every transmission to the well or pipe are substantially the same, with small variations due to surface imperfections. In an embodiment, the receiving window Rx may be tightly framed around the inner and outer surfaces of the tubular or pipe, i.e. the time for recording reflections is timed to start just before the inner specular reflections and stop just after the outer specular reflections of the emitted ultrasound pulses. However, it is common for the imaging device 10 to be off-center of the tubular (i.e. the longitudinal axes are parallel but not aligned), a condition called eccentricity, resulting in varying times of flight depending on the imaging angle Θ. In embodiments, the receiving window Rx is extended to capture reflections from an off-center imaging device, or to capture signals corresponding to additional reflected and resonant signals from other known features of the tubular. In an embodiment, a wavefront is steered based on a radius or curvature of a boundary of a surface of a target 2 and the eccentricity of the imaging tool 10 within the tubular target, which have been determined or measured by the tool.

After areas of the target are captured from plural angles and then receive beamformed to create plural reconstructed images, the step of compounding can be used to combine each of these reconstructed images to create a compounded image using summation of data in the overlapping zone. The summation can be coherent (using RF or I/Q data) or envelope data (B-mode). The receive beamforming reconstruction will depend on the transmit delays and geometry of the transducer array. The individual angled images are shifted to the same locations, and corresponding pixels in each image are summed to create pixels of the compounded image. The compounded image removes noises that are not coherent in the individual images, reinforces reflectors seen in plural angles, and smooths over glints present in only one of the images. In embodiments, a band pass angular filter is applied to the imaging data frame. In embodiments, a band stop angular filter is applied to the imaging data frame. In embodiments, f-k space or k-space domain filters targeting specific frequencies and angles, such as high spatial frequencies, are applied to the imaging data frame after beamforming.

After the ultrasound data has been filtered and corrected, it may be rendered for display. A rendering engine may reside in software or on a GPU and has numerous standard rendering algorithms to output a visually pleasing 2D image. The reflection signals may be displayed to a user in their raw signal form, whereby the 2D image is created from pixels separated by the signal's Time of Flight, and wherein pixel brightness is proportional to signal strength. Known rendering engines normally operates on pixels provided in Cartesian space, so a Cartesian voxel to display will be fetched from several polar coordinate voxels, LUT corrected, combined and then scan converted to Cartesian.

In an embodiment, a radial transducer array 12 creates an image frame by imaging an entire 360° cross-section of the target 2. In physical memory, the frame is stored “unwrapped.” Thus, although a frame for a radial array stores scanlines in order from 0 to 360° in memory, the two ends are in fact neighbors in the real-world tubular. Thus, algorithms that slide across multiple neighboring scanlines should also wrap around the end scanlines.

In addition to standard rendering options such as ray marching, texturing, and lighting, application-specific rendering may be applied to convey surface roughness, material reflectivity, attenuation, impedance and tubular defects. While some of these effects have no analogue in camera imaging, they highlight features detectable by ultrasound waves, especially those relevant to tubular structural integrity. For example, a small crack that is invisible to cameras may create a ringing ultrasound wave that can be displayed in a differentiating way on the monitor.

With further processing, a geometric model of the target or tubular may be created. Using edge detection and surface finding techniques, the processor can create a mesh of the tubular for analysis. Such analysis may include measuring diameter, lengths, connections or identifying damage and perforations.

In an embodiment, a transducer array 12 is used to sequentially emit ultrasound waves to insonate a surface of a target, for example the inner diameter of a tubular, at multiple angles. In embodiments, the surface is insonated with a plane wave, and the angle corresponds to the angle of incidence with respect to the normal of the surface. For example, for a flat surface, a plane wave with a flat wavefront is emitted, and for a curved surface, a divergent wave with a curved wavefront is emitted, and in both cases, the wavefronts are such that they always strike the surface of the target at the desired angle. The angle is chosen based on various parameters, such as the density of a fluid contained within a tubular. For example, the tubular is imaged at −20°, 20° and 0° when it contains water, and the tubular is imaged at −16.5°, 16.5° and 0° when it contains crude oil. Ultrasound reflections are received for the waves emitted for each of the angles. A target is insonated using steered transmissions using multiple angles to transmit waves such that they impact the surface of the target at a flat, 0° angle, and with positive and negative non-zero degree angles. The flat transmission of 0° is commonly used for acquiring surface characteristics such as geometry and surface defects. Steered transmissions are used to detect, locate and size defects or flaws within the target.

### Surface Adaptive Beamforming

In an embodiment, a surface adaptive beamforming process is carried out by the imaging tool 10. Surface adaptive beamforming dynamically adjusts beamforming parameters for an imaging tool based on surface characteristics and geometry of the inspected target, to compensate for differences between a true and assumed or expected location of a transducer array with respect to a target surface, such that data acquisition is optimized. In embodiments, adjusting beamforming parameters comprises updating transmit and/or receive delays for one or more transducer arrays on the imaging tool. In embodiments, surface adaptive beamforming is performed during transmit and receive beamforming. In embodiments, surface adaptive beamforming is performed during receive beamforming. In operation, signals are first transmitted and received by transducer arrays on an imaging tool using predetermined parameters for a known or expected target surface profile based on, for example, preliminary scans or utilizing known or measured geometric data of the tool and target. Steering and focusing of the waves is performed based on an expected standoff distance from the transducer array 12 to a target surface 2. An updated target surface and geometry are then determined by the imaging tool, and an updated representation of the target is generated. In some embodiments, updated receive delays for surface adaptive beamforming are determined based on the intensities of received ultrasound signals. In some embodiments, updated receive delays for surface adaptive beamforming are determined based on corresponding transmit delays for transducer elements of a transducer array. Differences between an expected and detected location and geometry may be due to one or more of several factors including, but not limited to, dents, wall loss, eccentricity of the target, or deviation from an expected standoff distance. Beamforming parameters are then dynamically adjusted in real-time or near real-time, including but not limited to, modifying transmit delays, modifying receive delays, and modifying steering angles, to ensure that the ultrasonic beams are optimally focused on the target surface or at desired subsurface depth. The dynamic parameter adjustments are made in real-time to account for any variations in the surface characteristics or geometry as an imaging tool is deployed through or over a target, ensuring that the ultrasonic waves are directed precisely where needed. This method is particularly useful when dealing with complex geometries or varying surface conditions.

Ultrasound signals emitted and received by transducer arrays on the imaging tool as described herein are used to acquire data for a section or region of a surface of the target 2, such as an interior surface of the tubular. In embodiments, the acquired data of the surface is used to further characterize the surface and to compare it to an expected location or geometry of the target surface. In further embodiments, sensor measurements from one or more of a plurality of radial sensors are used to further characterize a detected target surface. In embodiments, sensors coupled to sensor arms 17 are used to estimate the location of a transducer array with respect to the body of a sensor vehicle. In embodiments, sensors coupled to centralizer arms are used to estimate the eccentricity of a tubular target, and the location of a sensor vehicle within the tubular target. In embodiments, inner and outer surfaces determined from ultrasound data acquired by a plurality of transducer arrays are used to estimate the eccentricity of a tubular target, and the location of a sensor vehicle within the tubular target, as described elsewhere herein. In embodiments, a three-dimensional representation of the tubular target is generated based on acquired ultrasound data and as described elsewhere herein, is used to estimate an eccentricity of a tubular target, and the location of a sensor vehicle within. In embodiments, the distances from each transducer array in the sensor vehicle and the corresponding curvatures of the various regions of the target corresponding to the areas insonated by the corresponding transducer arrays are determined.

In embodiments, the received ultrasound signals are used to generate an updated characterization of the target surface. In this context, received ultrasound signals include raw RF signals, I/Q signals, beamformed images, filtered images, or in general, using the received ultrasound signals to determine the location of a target surface within a field of view of a transducer array or multiple transducer arrays. The received ultrasound data is used to determine features of the target including, for example, the location of an inner surface of the target, location of an outer surface of the target, an eccentricity of a cross section of the target at the location of the transducer array, determining a crack measure value, and determining a wall loss value. As a result, a detailed representation of the target surface is generated. In embodiments, the received ultrasound signals are processed scanline by scanline to detect a target surface. In some embodiments, the received ultrasound signals are processed scanline by scanline to determine a scanline delay corresponding to a transducer array/target surface configuration, based on determining when a scanline signal is over a predetermined threshold. In some embodiments, scanline delays are determined based on time-reversed transmit delays for the corresponding transducer elements in an array. In embodiments, the received ultrasound signals are processed frame by frame to detect a target surface. In embodiments, signal intensity or pixel intensity is used to identify regions of strong reflections corresponding to a target surface location, where values greater than a predetermined threshold are selected. In alternative embodiments, a heat map image is generated to identify the brightest reflections around the surface. In embodiments, edge detection algorithms common in image processing, such as Sobel filters, particularly optimized for edges normal to the direction of the wave, are used to determine the surface location. In alternative embodiments, implementations of machine learning and deep learning architectures including one or more of convolutional neural networks (CNN) and transformers are used to determine surface location within an image frame. In embodiments, features corresponding to a target surface are extracted and used to generate a target surface model. In embodiments, ultrasound signals and detected features are used to generate local shape models defining the target surface with sufficient resolution to represent surface imperfections such as pitting, corrosion, cracks and other local variations in the target surface. In embodiments, ultrasound signals and detected features are used to generate global shape models defining the target surface to represent geometric features, such as cross-sectional deformations and eccentricity of a tubular target. In embodiments, ultrasound signals, detected features and generated shape models, all of which lie on two-dimensional image planes, are combined with sensor measurements and known imaging tool configurations to generate three-dimensional models and representations of a target surface. As such, an updated characterization of a target surface can include representations of local surface imperfections, more general representations of the shape of a cross-section or region of a target surface, and a representation of an imaging tool location with respect to the target.

In a non-limiting example, received ultrasound signals are processed frame by frame, such that a plurality of maximum intensity points is identified in each frame, and a distance from a transducer array 12 to a target surface is determined based on the identified maximum intensity points. In another non-limiting example, received ultrasound signals are processed frame by frame, such that maximum intensity points with values greater than a predetermined threshold are identified in each frame, and a target surface is set as the spline curve fit to the identified points. In another non-limiting example, received ultrasound signals are processed frame by frame, such that maximum intensity points with values greater than a predetermined threshold are identified within each frame, where a weight is assigned to each point based on the intensity of each point, and a target surface is set as the spline curve with least squares fit to the identified weighted points. In a further non-limiting example, received ultrasound signals are processed frame by frame, such that one or more of a CNN and transformer creates a segmentation mask based on the received ultrasound signals, and a target surface is extracted from the segmentation mask via postprocessing. In an additional non-limiting example, received ultrasound signals are processed as a three-dimensional volume, such that one or more of a CNN and transformer creates a segmentation mask based on the received ultrasound signals, and a target surface is extracted from the segmentation mask via postprocessing.

The imaging tool 10 uses an updated characterization of a target surface to determine updated beamforming parameters. In embodiments, the imaging tool employs a ray tracing process for imaging a target, such as that described in GB patent application no. GB2115164.2A, filed Oct. 21, 2021, now granted patent no. GB2612093B. The process for imaging a target comprises insonifying a target with a plane wave, defining a target surface boundary model, tracing acoustic rays from a transducer array to a grid of positions or pixels within a region of interest including the target, and sampling and summing delayed RF channel signals for transducer elements that are the terminus along rays from each pixel for receive beamforming. Delays are calculated for each transducer element 13 based on a return trip distance for the plane wave to reach a given coordinate, and then reflect back to said element, taking the speed of sound of a medium and the target into consideration. For pixels beyond the target surface, the target surface boundary model, which includes intersection points and corresponding surface normal vectors, is considered to calculate transmitted rays into the target and reflected rays using a ray tracing model. The sampled and summed RF signals are used to estimate reflections for each pixel in an image. With an updated characterization of the target surface, the target surface boundary model for the ray tracing process will yield more accurate ray traced paths, which in turn result in reduced noise and artifacts in the summations for each pixel and improved image quality.

In embodiments, transmit beamforming delays are adjusted such that the emitted wavefront from a transducer array is steered, focused and/or otherwise directed towards a desired target surface. For example, delays are adjusted such that a transducer array insonates a curved surface of the target with a polar wavefront based on an updated standoff distance between a transducer and target surface determined from an updated characterization of a target surface. In this manner, emitted wavefronts are focused at distances F corresponding to the measured surface distance r, including the orientation of the surface with respect to the transducer array. In embodiments, delays are adjusted such that a transducer array insonates a curved surface of a target with a steered wave, based on an updated characterization of a target surface. Transmit beamforming delays are calculated based on ray tracing or other known methods for beamforming, using the updated characterization of the target surface. In embodiments, a first transmit step, a receive beamforming step including ray tracing, the identification of a target surface such as an inner diameter (ID) of a tubular, a re-computation step to determine updated transmit beamforming parameters, and a second transmit step using re-computed parameters are carried out on the imaging vehicle using one or more local processors, preferably FPGAs. In an embodiment, these steps are executed in about 100 μs for each transducer array in an imaging vehicle.

In an embodiment, a surface adaptive beamforming process is carried out by the imaging tool 10 for a single transducer array 12. During a first step, an ultrasound wave is emitted by a transducer array and reflections are received by the same transducer array, based on predefined or previously determined transmit and receive parameters. In an embodiment, a polar plane wave is emitted by the transducer array such that this divergent wave, corresponding to a plane wave in polar coordinates, strikes a curved surface of a target at a zero-degree angle with respect to the surface normal. The reflected ultrasound wave received at the transducer array will contain a strong specular component reflected from the target surface. An updated characterization of the target surface is generated as described herein, and updated parameters are generated. In an embodiment, a maximum intensity location along each scanline is determined to generate candidate points for a target surface and a surface model is fit to the plurality of candidate surface points. In embodiments, updated receive beamforming delays are determined based on the updated surface model. Subsequently, additional plane waves are processed using the updated receive beamforming delays. In embodiments, the additional planes waves include one or more of a polar wave and one or more of a steered wave. The angle is chosen based on various parameters, such as the density of a fluid contained within a tubular. In embodiments, wavefronts are emitted such that they strike a target surface at opposing angles with respect to a normal direction of said target surface, for example in the range −30° to −10° and 10° to 30°, respectively. In a non-limiting example, a target tubular is imaged at −20°, 20° and 0° when it contains water, and a target tubular is imaged at −16.5°, 16.5° and 0° when it contains crude oil. In embodiments, multiple waves are emitted during a first step, and an updated surface characterization of a target surface is generated based on signals received for a first emitted wave and receive beamformed using predetermined or previously determined parameters, and signals received for subsequent waves are receive beamformed using updated beamforming parameters.

In an embodiment, a surface adaptive beamforming process is carried out for a transducer array on an imaging tool vehicle based on data acquired by another transducer array on the same vehicle. In an embodiment, an imaging tool vehicle 10a comprises a plurality of outward facing transducer arrays, each radially and axially offset from each other along the circumference and length of the imaging tool, in a radially staggered configuration, such as those illustrated in FIG. 2 and FIG. 4B. During a first step, one or more ultrasound waves are emitted by a first transducer array from the plurality of transducer arrays, and reflections are received by the same first transducer array. Waves are transmit and receive beamformed based on predefined or previously determined transmit and receive beamforming parameters. In embodiments, the transmitted waves include one or more polar waves and one or more steered waves. An updated characterization of the target surface is generated as described herein, and updated parameters are generated. In an embodiment, sensor measurements are also used to generate the updated characterization of the target surface. For example, in an embodiment the imaging vehicle 10c comprises a plurality of sensor arms 17, with sensors for determining a position and/or eccentricity of a tool vehicle within a tubular target, including, but not limited to, potentiometers, rotary encoders, Hall effect sensors, gyroscopes, or other electromagnetic or mechanical sensors. In combination with the received ultrasound data, sensor arm data is used to locate a target surface with respect to an imaging tool and the plurality of transducer arrays, to generate the updated characterization of the surface target. Updated beamforming parameters are then generated for a second transducer array for the imaging vehicle based on the updated characterization of the target surface and known configuration of the imaging vehicle, which are then used as previously determined parameters during subsequent transmit and receive steps. The process is then repeated for the subsequent transducer arrays from the plurality of transducer arrays.

In an embodiment, data acquired by one or more transducer arrays on a first imaging tool vehicle are used to perform a surface adaptive beamforming process for one or more transducer arrays in a second tool vehicle. Beamforming parameters for one or more transducer arrays 12 in a second sensor vehicle, located downstream of the first sensor vehicle, are updated based on an updated surface characterization and imaging tool location with respect to a target, such that updated transmit and receive parameters cause the resulting ultrasound wavefronts to be optimized for the imaging tool location with respect to the measured surface and geometry of the target tubular. With reference to FIG. 8A and FIG. 8B, a tool train comprising multiple vehicles 10a, 10b, 10c is illustrated travelling through a tubular target 2 at a velocity V. In embodiments, the tool train comprises a sensor vehicle 10a, a battery vehicle 10b, and a plurality of imaging vehicles 10c. In embodiments, a sensor vehicle 10a comprises a plurality of sensor arms 17, including sensors for determining a position of a tool vehicle, and therefore the tool train, within a tubular target. In embodiments, an imaging vehicle 10c comprises a plurality of sensor arms 17, including sensors for determining a position of a tool vehicle within a tubular target. In an embodiment, the plurality of sensors arms 17 on an imaging vehicle 10c further comprise outward facing transducer arrays 12. Sensors for measuring an angle or extension of sensors arms 17 include, but are not limited to, potentiometers, rotary encoders, Hall effect sensors, gyroscopes, or other electromagnetic or mechanical sensors.

During a first time-step, as illustrated in FIG. 8A, one or more ultrasound waves are emitted from a first transducer array on a first imaging vehicle. The ultrasound waves emitted include one or more of plane waves, polar plane waves, steered waves, or a combination of these. Reflected ultrasound energy is then received at the transducer array and is converted by the transducer elements to electrical signals. An updated characterization of the target surface is generated as described herein, and updated transmit and/or receive parameters are generated. In an embodiment, sensor measurements are also used to generate the updated characterization of the target surface, as described herein.

During a second time-step, as illustrated in FIG. 8B, the tool train has moved through the tubular target or pipeline, and a second imaging vehicle 10c is aligned with the target surface region that was imaged by the first imaging vehicle during the first time-step. In embodiments, the elapsed time between the first time-step and the second time step is calculated based on a known tool velocity and a known distance d between the first and second imaging vehicles, taking the known configuration of transducer arrays into account. One or more ultrasound waves are emitted from a transducer array on the second imaging vehicle, using updated parameters based on the updated characterization of the target surface, based on the same region of the target surface. In an embodiment, a transducer array on the second imaging vehicle is radially aligned with a transducer array on the first imaging vehicle. In this manner, deviations between an expected surface location and a measured surface location can be corrected for a second transducer array. Deviations may be due to wall loss or corrosion, target deformation, and tool misalignment. In addition, the orientation of a surface with respect to a tool vehicle and a transducer array can also be considered. In embodiments, beamforming parameters can be further refined using a single transducer array on the second imaging vehicle, as described above. The adaptive nature of the beamforming process ensures that the ultrasonic beams are always focused at a desired distance from a transducer array, such as at a target surface, leading to more accurate measurements from high resolution images.

### Multi-Wave and Multi-View Imaging

One or more transducer arrays on imaging tool 10 are used to insonate a target using multiple waves to detect cracks and to characterize wall loss in the target using a multi-view imaging process. Multi-view imaging comprises emitting and capturing ultrasound reflections from a target at multiple angles to detect flaws including but not limited to cracks, pitting wall loss or other defects.

In embodiments, one or more zero-degree, polar plane waves are emitted from a transducer array, such that the directions of the wavefront are aligned with surface normal vectors of the target surface, and echoes are reflected back to the transducer array. In embodiments, the reflected ultrasound data is receive-beamformed such that specular reflections of a first proximal target surface and/or a second distal target surface are imaged. Signal intensities for this data will be highly correlated to the location of the target surface(s), and these regions are used to measure the location of the target surfaces. In embodiments, the reflected ultrasound data can also be receive-beamformed, for example, using a ray tracing algorithm, to consider different types of reflections from flaws within the target. Non-limiting examples including detecting and identifying mode-converted T waves from crack body reflections and L-wave reflections from crack tip diffractions. In such embodiments, the data is filtered to remove specular reflections of the first and second target surfaces while retaining mode-converted L-wave reflections, which results in high signal intensities for regions that contain flaws perpendicular to the target surface. The resulting images are used to size and locate flaws within a target, in combination with the measured locations of the first and second target surfaces obtained using, for example, specular reflections.

In embodiments, one or more angled polar plane waves are emitted from a transducer array, such that the directions of the wavefronts strike the surface of a target at a desired angle. In embodiments, the wavefronts strike the surface of the target at −20 and 20 degrees. In embodiments, the wavefronts strike the surface of the target at −16.5 and 16.5 degrees. In this configuration, flaws or defects within a target will interfere with the transmission of an ultrasound signal through the target and generate signal gaps or voids in data received by the transducer array for some angles, forming a signal shadow in the received ultrasound data, and will generate reflections of the flaws for other angles. The signal shadows and flaw reflections can be alternately filtered, so that either one or the other is retained, and processed to size and locate flaws within the target, in combination with the measured locations of the first and second target surfaces obtained from zero-degree plane wave reflections. This method is particularly useful for identifying cracks that may not produce strong reflections.

In an embodiment, the reflected ultrasound signals are filtered such that the signal gaps are eliminated from the receive beamformed images. For example, receive beamforming delays are calculated using a ray tracing algorithm, and a specular band-pass angle filter configured to allow specular reflections from a predetermined range of angle directions is applied, which attenuates reflections from directions outside of the predetermined range. In an embodiment, the band-pass filter allows reflection angles in the range of −60 to 60 degrees. In this manner, any signal gap artifacts are removed from the beamformed images, and reflections corresponding to the flaw or defect, remain. In an embodiment, beamformed and filtered images generated from waves emitted at different angles are compounded, for example using additive compounding, multiplicative compounding or maximum value compounding, to generate a compounded image. Noise is reduced in a compounded image and visibility of defects is enhanced by reinforcing the reflections seen from multiple angles. The beamformed images, or in the alternative, the compounded images, are processed to size and locate flaws within the target based on the pixel intensity values, in combination with the measured locations of the first and second target surfaces obtained from zero-degree plane wave reflections.

In an embodiment, the reflected ultrasound signals are filtered such that the signal gaps are retained in the receive beamformed images, while reflections from flaws are filtered out. For example, receive beamforming delays are calculated using a ray tracing algorithm, and an anti-specular band-stop angle filter configured to attenuate specular reflections within a predetermined range of angle directions is applied, which attenuates reflections from directions within of the predetermined range. In an embodiment, the band-stop filter allows reflection angles outside the range of −60 to 60 degrees. In this manner, any signal gap artifacts are retained within the beamformed images, and reflections corresponding to the flaw or defect, are removed. In an embodiment, beamformed and filtered images generated from waves emitted at different angles are compounded, for example combined using additive compounding, multiplicative compounding or maximum value compounding, to generate a more detailed and accurate compounded image. The beamformed images, or in the alternative, the compounded images, are further processed to characterize the shapes of the signal voids, which are proportional to the size of a flaw, within the beamformed or compounded images, based on the resulting pixel intensity values. The shapes of the signal voids are used to size and locate flaws within the target, in combination with the measured locations of the first and second target surfaces obtained from zero-degree plane wave reflections.

### Receive Beamforming Using Ray Tracing

In an embodiment, the imaging tool receive beamforms ultrasound data received at a transducer array using ray tracing, as described above. As rays are calculated for one or more transducer elements in a transducer array for each pixel or cell of interest based on the geometry of the transducer array and of the target surface, it is possible to estimate a ray's angle of incidence for each of the one or more transducer elements as well as the reflection angle that would have generated the event associated with a transmit and receive rays. In an embodiment, rays with very high reflection angles will have an increasingly lower impact on signal intensity, and their contribution is removed through filtering during beamforming. In embodiments, filtering is performed by determining channel weights for a plurality of channel data signals. Angle-dependent weights are assigned based on a ray's reflection angle, and included in the calculation of a pixel or cell intensity by multiplying the received signal by a corresponding weight. In embodiments, Time of Flight (ToF) delays are calculated for all rays. In embodiments, ToF delays are calculated for rays with weights greater than a predetermined threshold. In embodiments, weights for rays with angles between 0-55° are set to 1, such that the signals values are not affected, weights for rays with angles greater than 70° are set to 0, such that signal contributions are eliminated, and cosine attenuation is applied for angles between 55-70°, with appropriate shifting and scaling such that the weight values smoothly transition between 1 and 0. In an embodiment, the product of a weight and a signal where a weight has a value equal to 1 is not carried out and the signal intensity is used, in order to avoid a multiplication operation which in turn increases the computational efficiency of the filtering process. In an embodiment, the product of a weight and a signal where a weight has a value equal to or approximating zero is not carried out, and the signal intensity is set to zero, to increase the computational efficiency of the process. The impact of applying weights as described above is twofold, as firstly, an increase in processing efficiency is obtained by eliminating calculations for rays with reflection angles greater than a predetermined threshold, and secondly, an angle-dependent filtering effect is achieved.

In an embodiment, predetermined imaging parameters are generated for an expected configuration for an imaging tool and target. Based on the expected configuration, ray tracing is performed offline, and Time of Flight delays are calculated for all transducer elements and apertures. Delays are stored on the imaging tool, and recalled during imaging to generate an image frame without the need to perform ray tracing for each frame, when using predetermined parameters. Delay table values are converted to angle values, and angle weights are applied to the converted delay values, which are then used to weight the channel signals to achieve angle-dependent filtering as described above.

As will be apparent to those of skill in the art, the physical configuration of a transducer element or a transducer array will result in an intrinsic filtering effect, dependent on the angle of incidence of a wavefront arriving at said transducer element or transducer array. In other words, a transducer element will have a given angle-dependent response due to factors including its physical and geometric properties and the frequency of the emitted and received signals. A principal contributing factor is that a transducer element, such as a PZT transducer element, will generate a strong response for pressure waves that compress the element, and will have a minimal response to pressure waves that arrive from lateral directions, which form larger angles with respect to the transducer. Such angle dependent response is typically depicted as a polar plot. For certain configurations and signals of interest, the angles of incidence of a wavefront on a transducer element will be contained within a narrow angular range, within which the response of a transducer element can be considered constant. In other words, for such configurations, signals of interest are not expected to arrive at a transducer element outside of the narrow angular range, where attenuation in signal response would be expected. However, signals arriving from directions outside of the narrow angular range may suffer unwanted attenuation, equivalent to applying an angular filter for directions outside the given angular range.

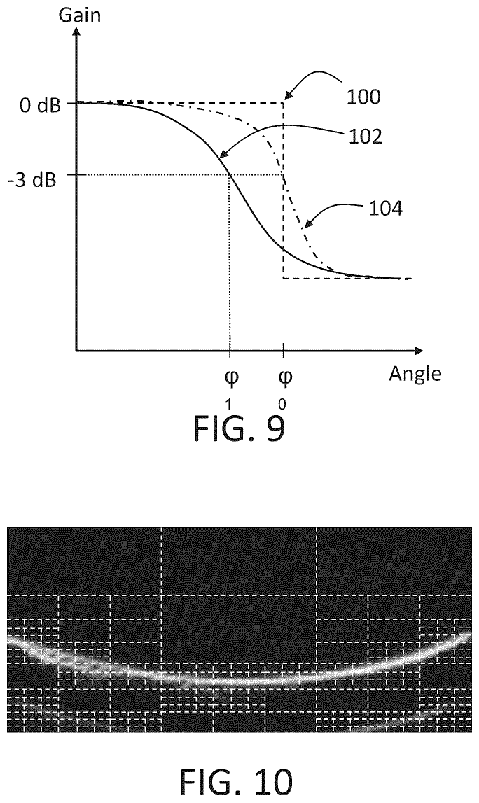

In embodiments, a compensation filter is applied to received data to counter expected signal attenuation for higher incidence angles arriving at a transducer element. As will be apparent to those of skill in the art, an ideal filter would allow all signals within a desired range to pass, and would block all signals outside of the desired range, forming a low-pass step function, as illustrated by 100 in FIG. 9. As described above, a transducer element, an aperture in a transducer array, or an entire transducer array will have an angle dependent response, which may or may not coincide with a desired angular range. For example, the angle dependent response may have a 3 decibel (dB) signal drop at an angle φ₁ instead of the desired cutoff angle of [φ₀], as illustrated by 102 in FIG. 9. As a result, signals with directions in the angular range of [φ₁, φ₀] will be overly attenuated. A compensation filter Fc is applied to the data to boost the response for signals with incident directions forming angles within the angular range of [φ₁, φ₀] such that the −3 dB cutoff, or other desired attenuation drop, is set to a desired angle. The resulting response of the transducer, after the filter is applied is illustrated by 104 in FIG. 9. In this manner, in addition to calculating delays for beamforming for a given ray direction, signals that arrive at a transducer with a high incident angle are boosted during the beamforming process, and any attenuation due to the physical configuration of the transducers is reduced.

In an embodiment, a method for determining a compensation filter for a transducer element or array is disclosed. During a first step, an angular-dependent response is determined for a transducer element or array for a range of incident ultrasound energy wave directions, for example in the range of 0 to 90 degrees. As a non-limiting example, an angular-dependent response is determined based on simulation data or measured data. An angular cutoff is determined from the angular-dependent response. The angular cutoff is compared to a desired cutoff of angular incidence for an application, for example, based on imaging a tubular target using a PZT transducer. A plurality of weights for a compensation filter is then determined if the desired cutoff of angular incidence is greater than the angular cutoff of the angular-dependent signal response. For example, parameter values for a compensation filter are selected such that the application of the compensation filter to the angular-dependent signal response result in filtered angular cutoff equal to the desired cutoff of angular incidence. In an embodiment, a transducer element or array will have a low-pass response, and filter weights are further determined such that the combined response of the transducer and the filter corresponds to a low-pass response with a shifted angular cutoff, to the desired angle. In embodiments, one or more processors are configured to determine filter weights to be applied to each channel. In embodiments, filter weights for each channel are predetermined, stored on the imaging tool, and one or more processors are configured to weight the channel signals in order to achieve the angle-dependent filtering as described above.

As a result, by considering the directionality of a transducer element and its ability to receive energy off the normal direction to the same, a more accurate signal is reconstructed using ultrasound signals arriving at incident angles within a desired range, and filtering out those signals arriving from directions that are not relevant to reconstruction of an image frame. For example, signal refraction in metal can generate signals with incident angles that arrive from directions outside of a typical angular response range for a PZT.

### Adaptive Multiresolution Beamforming

When generating an image frame using receive beamforming with ray tracing, a plurality of rays is typically calculated for multiple grid points. The separation between the grid points will directly impact the final image frame resolution, where closer-placed grid points will generate a higher resolution image frame. However, a typical tubular target configuration, imaged with a fluid medium, for example, may generate image frames with regions of very low signal intensity, and for which high resolution may not be required. Nonetheless, multiple rays are typically calculated for these regions and occupy processing and time resources that could otherwise be used. A method of adaptive multiresolution beamforming is disclosed herein to improve the efficiency of image frame formation while saving computational resources.

An adaptive multiresolution beamforming process involves defining a region of interest to generate an image frame. This region is then divided into a coarse grid of cells covering its full extent. A feature position is defined at the center of each cell and a plurality of rays are generated and propagated as in known in the art for receive beamforming. For example, ray tracing is used to determine beamforming directions based on a cell feature position and the location of the received signal in a transducer array, such as an aperture center location, or a transducer element location. A summed signal for each grid cell is determined based on the generated rays, and a measure of the total cell signal energy for each cell is determined. If the total cell signal energy is less than a predetermined threshold, the cell is subdivided to a maximum desired resolution, and the energy value is mapped to each of the subdivided cells, thereby increasing the computational efficiency of the process. If the total signal energy is greater than the predetermined energy threshold, the cell is subdivided into further smaller cells, and the process is repeated, until the maximum cell resolution is reached, or a subdivided cell has a total signal energy below the predetermined threshold.

In an embodiment, each cell is subdivided into a 3 by 3 grid of subdivided cells, as illustrated in FIG. 10, and a feature position is defined based on the central subdivided cell. In embodiments, the feature position is defined at a position corresponding to the center of the central subdivided cell edge distal to the transducer array. In an alternative embodiment, each cell is subdivided into a 2 by 2 grid of subdivided cells, and a feature position is defined at a virtual coordinate at the center of the cell. In an embodiment, the cells are equally sized. In an embodiment, the cells define a rectangular shape. In embodiments, the cells define a square shape. In embodiments, the rays are filtered based on incident angles as described herein. In embodiments, the predetermined threshold value is determined via noise floor studies for the imaging tool.

In an embodiment, the configuration of cells for which a total cell signal energy was below a predetermined threshold is stored in association with an image frame. A subsequent image frame is then generated starting with the stored grid configuration of the of the previous image frame.

As described above, ray tracing, based on a feature location corresponding to a cell and the location of a transducer element or aperture, is used to determine a plurality of ray directions and corresponding signal delays, to obtain a summed signal for said cell. One or more processors may implement an optimization process to determine the distribution of ray angles from a stationary cell feature in a region of interest to a given transducer element, by minimizing the travel time from the feature to the element to obtain a ray, given a target surface, target material, medium and standoff. In an embodiment, the minimization is implemented using one or more parallel processors, such as graphics processing units (GPUs). A plurality of ray directions for a given feature defined by a first cell will be very similar to a plurality of ray directions for features defined adjacent cells, and will therefore have similar computational complexity and will use similar data to arrive at a result. Subsets of grid points defined by adjacent cells are stored in arrays in contiguous memory blocks such that ray tracing calculations for said subsets of grid points are processed together, by grouping the threads in warps, the base unit used to schedule both computation on Arithmetic and Logic Units and memory accesses, and taking advantage of the similarities in computational complexity and data. As a result, threads for adjacent cells will have similar execution time. In an embodiment, a common upper bound is set for threads within a warp, for example, corresponding to a desired resolution or number of iterations, further ensuring threads within a warp will finalize substantially concurrently. In an embodiment, a Golden Search minimization algorithm is used to determine ray directions for all threads within a warp, where an upper bound on the number of iterations is set ensuring an upper bound on execution time.

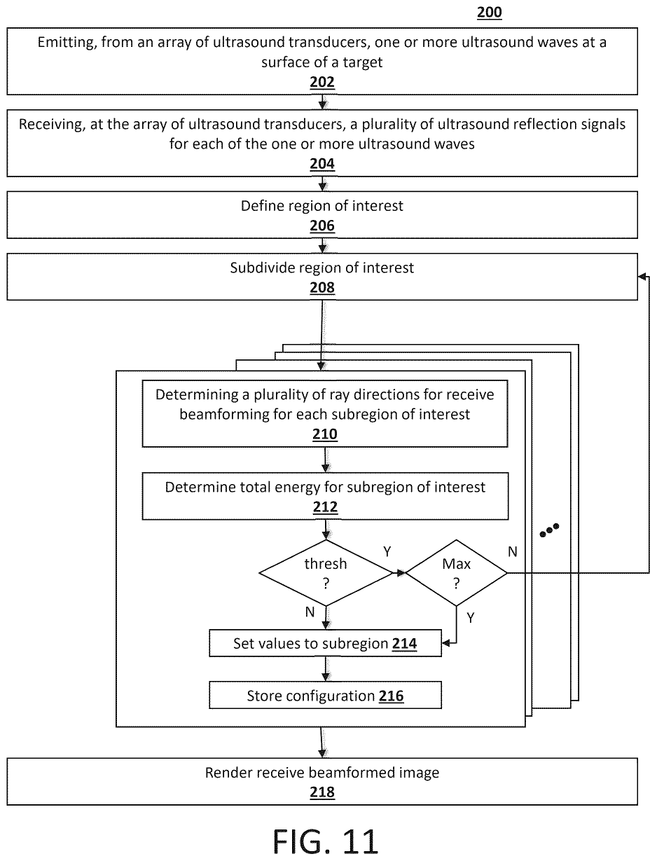

FIG. 11 is a flowchart of an example process 200, for an optimized process for ray tracing to generate an image frame, as described herein. In some implementations, one or more process blocks of FIG. 11 may be performed by a device.

As shown in FIG. 11, process 200 may include emitting, from an array of ultrasound transducers, one or more ultrasound waves at a surface of a target (block 202). As also shown in FIG. 11, process 200 may include receiving, at the array of ultrasound transducers, a plurality of ultrasound reflection signals for each of the one or more ultrasound waves (block 204). As further shown in FIG. 11, process 200 may include defining a region of interest to be beamformed (block 206). As also shown in FIG. 11, process 200 may include subdividing the region of interest into cells (block 208). As further shown in FIG. 11, for each cell, process 200 may include determining a plurality of ray directions for receive beamforming for each cell (block 210); determining a total cell energy based on the received ultrasound data (block 212); determining whether the received ultrasound data is greater than a predetermined threshold, determining if a maximum predetermined number of subdivisions for each cell has been reached, or alternatively, if a maximum execution time has been reached, or repeating the process from the subdivision step in block 208, for the cell, to form a receive beamformed image. As also shown in FIG. 11, process 200 may include setting a value proportional to the determined cell energy for the cell (block 214). As further shown in FIG. 11, process 200 may include storing the configuration of the subdivided cells (block 216). As further shown in FIG. 11, process 200 may include rendering the receive beamformed image (block 218).

Although FIG. 11 shows example blocks of process 200, in some implementations, process 200 may include additional blocks, fewer blocks, different blocks, or differently arranged blocks than those depicted in FIG. 11. Additionally, or alternatively, two or more of the blocks of process 200 may be performed in parallel.

The quantification of wall loss, including the accurate quantification of cracks, is important to determine the structural integrity of a tubular or pipeline, such as by calculating the burst pressure a wellbore tubular or pipeline, which depends on accurate values of wall thickness. If the material is assumed to be homogeneous and isotropic, and the stress distribution is uniform, burst pressure is calculated using Barlow's formula, given by P=(2*S*t)/D, where P is the burst pressure, S is the material's yield strength, t is the wall thickness of the tubular or pipeline, and D is the outer diameter. A conservative calculation of burst pressure can be obtained using the River Bottom Method, to account for potential defects such as corrosion or wall thinning, which modifies Barlow's standard formula by incorporating a correction factor to account for these imperfections by using the effective wall thickness, which reduces wall thickness by the depth of the deepest defect or corrosion pit. Finite element analysis can also be used to calculate burst pressure, where a detailed geometric model of the wellbore tubular or pipeline is generated, which is then discretized into a finite element mesh consisting of numerous small, interconnected elements. Accurate values for wall thickness are critical for obtaining accurate simulated results, especially in cases involving complex geometries, material inhomogeneities, or localized defects. Determining burst pressure is critically important as it ensures the structural integrity and safety of the wellbore tubular or pipeline under operational pressures, especially in environments where corrosion and other forms of degradation are prevalent. Accurate burst pressure calculations help prevent catastrophic failures, environmental hazards, and costly downtimes by ensuring that the materials and design specifications can withstand the maximum internal pressures they will encounter during their service life.

Terms such as “top”, “bottom”, “distal”, “proximate” “downhole”, “uphole”, “below,” “above,” “upper, downstream,” are used herein for simplicity in describing relative positioning of elements of the conduit or device, as depicted in the drawings or with reference to the surface datum. Although the present methods, systems and devices have been described and illustrated with respect to preferred embodiments and preferred uses thereof, it is not to be so limited since modifications and changes can be made therein which are within the full, intended scope as understood by those skilled in the art.

While many specific details have been provided for a thorough and complete understanding of the embodiments as described herein, it will be understood by those of ordinary skill in the art that said embodiments can be practiced even without these specific details. In other instances, detailed descriptions of components, methods and procedures have not been provided to avoid obscuring the relevant features being described. Further, the embodiments described herein should not be considered as limiting the scope of the method, system and devices as recited in the claims.

1. A method of imaging a manufactured part for detecting defects using a phased array ultrasonic transducer, the method comprising:
emitting one or more ultrasound waves using the phased array ultrasonic transducer;
receiving reflected ultrasound waves at the phased array ultrasonic transducer to generate a plurality of received signals, and storing the plurality of received signals;
generating a first image frame from the plurality of received signals via at least one cloud processor, based on an expected model of the manufactured part, the model including a representation of a surface of the manufactured part;
determining an updated model of the manufactured part, based on the first image frame;
generating a second image frame via the at least one cloud processor, by:
tracing rays from the phased array ultrasonic transducer to the manufactured part and back to the transducer, using the model;
determining angles of the traced rays;
generating channel weights for the plurality of received signals based on the angles of the traced rays;
calculating a time of flight (ToF) for the rays using the model;
using the ToF and channel weights, sampling and summing the stored plurality of received signals to calculate image values for pixels for the second image frame; and
assembling the pixels to generate the second image frame; and
generating one or more defect measures for the manufactured part based on the second image frame.

2. The method of claim 1, wherein the model representing the manufactured part further includes representations of one or more of: (i) a location of the phased array ultrasonic transducer; (ii) a geometry of the phased array ultrasonic transducer; (iii) a location of the manufactured part; (iv) a geometry of the manufactured part; (v) a speed of sound of a coupling medium between the phased array ultrasonic transducer and the manufactured part; and (vi) a speed of sound of the manufactured part.

3. The method of claim 1, wherein generating channel weights further comprises assigning a first weight when an angle of a traced ray is less than a first angular threshold, assigning a second weight when an angle of a traced ray is between the first angular threshold and a second angular threshold, and assigning a third weight when an angle of a traced ray is greater than the second angular threshold.

4. The method of claim 3, wherein the first angular threshold is 55°, the second angular threshold is 70°, the first weight is 1, the second weight is a scaled cosine function, and the third weight is 0.

5. The method of claim 1, wherein generating channel weights further comprises assigning channel weights to compensate for an angular-dependent response of the phased array ultrasonic transducer.

6. The method of claim 5, wherein assigning channel weights to compensate for an angular-dependent response of the phased array ultrasonic transducer, where a low-pass angular response cutoff of the phased array ultrasonic transducer is less than a desired angular response threshold, further comprises assigning channel weights for a range of angles of traced rays below the desired angular response threshold and above the angular response cutoff such that a filtered signal response of the phased array ultrasonic transducer is increased within said range.

7. The method of claim 1, wherein the one or more defect measures include a crack measure and a wall loss measure.

8. The method of claim 1, wherein emitting one or more ultrasound waves further comprises emitting one or more of a plane wave, a divergent wave, and a steered wave from the phased array ultrasonic transducer.

9. The method of claim 8, wherein emitting a plane wave further comprises emitting a full aperture plane wave.

10. The method of claim 8, wherein emitting a divergent wave further comprises emitting one of a polar wave and a spiral wave.

11. The method of claim 1, wherein determining an updated model of the manufactured part is further based on one or more of data from a location sensor for determining a location within the tubular, and a distance sensor for determining a distance travelled within the tubular.

12. A method of imaging a manufactured part for detecting defects using a phased array ultrasonic transducer, the method comprising:
emitting one or more ultrasound waves using the phased array ultrasonic transducer;
receiving reflected ultrasound waves at the phased array ultrasonic transducer to generate a plurality of received signals, and storing the plurality of received signals;
generating an image frame from the plurality of received signals via at least one cloud processor, based on an expected model of the manufactured part, the image frame defining a region of interest, by:
a) subdividing a current region of interest into a plurality of subregions of interest;
b) tracing rays for a single reflector back to the transducer, for each of the plurality of subregions of interest;
C) calculating a time of flight (ToF) for the rays using the model, for each of the plurality of subregions of interest;
d) using the ToF, sampling and summing the stored plurality of reflection signals to calculate an intensity value, for each of the plurality of subregions of interest;
e) repeating from a), when the intensity value is greater than a predetermined threshold and the current subregion has been subdivided less than a predetermined number of times, for each of the plurality of subregions of interest;
f) assigning a pixel value based on the intensity value to one or more pixels defined within the corresponding subregion, for each of the plurality of subregions of interest; and
g) generating the image frame based on assigned pixel values;
storing a configuration of subdivided subregions of interest for an image frame; and
generating one or more defect measures for the manufactured part based on the second beamformed image.

13. The method of claim 12, wherein the at least one cloud processor further comprises a graphics processing unit, and wherein generating the image frame further comprises grouping one or more of the plurality of regions of interest to be processed by a warp on the graphics processing unit.

14. The method of claim 12, wherein tracing rays for a single reflector back to the transducer further comprises defining a single reflector position within each of the plurality of subregions of interest.

15. The method of claim 12, wherein subdividing a current region of interest into a plurality of subregions of interest in a) further comprises subdividing a current region of interest based on a stored configuration of subdivided subregions of interest.

16. A system for imaging a manufactured part for defects, the system comprising:
an imaging device comprising one or more phased array ultrasonic transducers;
data memory for storing a plurality of received signals from the one or more phased array ultrasonic transducers;
at least one processor; and
a computer-readable medium storing instructions that, when executed by the at least one processor, cause the system to image the manufactured part by performing the method of claim 1.

17. The system of claim 16, further comprising at least two radially outward facing phased array ultrasonic transducers, preferably
radially staggered on the imaging device.

18. The system of claim 17, wherein the at least two phased array ultrasonic transducers are located diametrically apart.

19. The system of claim 17, wherein the method is performed simultaneously for each of the at least two phased array ultrasonic transducers.

20. The system of claim 16, the device further comprising a plurality of linearly coupled tool vehicles forming a tool train, wherein a first phased array ultrasonic transducer from a first tool vehicle and a second phased array ultrasonic transducer from a second tool vehicle are aligned in a radial direction, wherein the first image frame is generated from a plurality of received signals from the first phased array ultrasonic transducer and the second image frame is generated from a plurality of received signals from the second phased array ultrasonic transducer.
